(19) United States
(12) Patent Application Publication
(10) Pub. No.: US 2023/0199350 A1
(43) Pub. Date: Jun. 22, 2023

(54) OPTICAL SWITCHING DEVICE, OPTICAL SWITCHING SYSTEM, AND METHOD OF OPTICAL SWITCHING

(71) Applicant: Fujitsu Limited, Kawasaki-shi (JP)

(72) Inventors: Tatsuya TSUZUKI, Kawasaki (JP); Shigeru ISHII, Ota (JP); Takehiro FUJITA, Setagaya (JP)

(73) Assignee: Fujitsu Limited, Kawasaki-shi (JP)

(21) Appl. No.: 18/167,914

(22) Filed: Feb. 13, 2023

(30) Foreign Application Priority Data
Jun. 8, 2020 (JP) 2022-092945

(51) Int. Cl. H04Q 11/00; G02F 1/31

(52) U.S. Cl. CPC H04Q 11/0005; G02F 1/31; H04Q 2011/0009

(57) ABSTRACT

An optical switching device including: an input unit to which multichannel light beams are redundantly input; a channel tunable optical filter that confirms, from the received multichannel light beams, whether correct input of a channel for an output destination is included; and an optical switch that outputs, to an optical transfer device which is the output destination, any one of the multichannel light beams that includes the channel which has been correctly input.

### CROSS-REFERENCE TO RELATED APPLICATION

This application is based upon and claims the benefit of priority of the prior Japanese Patent Application No. 2022-92945, filed on Jun. 8, 2022, the entire contents of which are incorporated herein by reference.

### FIELD

The embodiment discussed herein is related to an optical switching device, an optical switching system, and a method of optical switching.

### BACKGROUND

A metro optical transfer system includes a plurality of optical add/drop multiplexers (OADMs). The OADMs are coupled to each other so as to form a ring shape via an optical transfer path such as an optical fiber. As described above, a ring network is built in the metro optical transfer system. As the configurations of the ring network, a first method and a second method are known. The first method uses two transponders for one wavelength. The second method uses one transponder for one wavelength. A technique of switching an optical path from an active optical transfer path to a standby optical transfer path in the second method is also known.

Other than the OADM, a reconfigurable OADM (ROADM) is known. It is desired that the OADM and the ROADM have the functions of efficiently flexibly building, changing, and managing a wavelength division multiplexing (WDM) network. For example, colorless, directionless, contentionless, and gridless (CDCG) functions are desired for the ROADM. The colorless function is a function of avoiding wavelength dependence (colored) limitations. The directionless function is a function of avoiding directional dependency (directional) limitations. The contentionless function is a function of avoiding contention limitations (contention) between the same wavelengths. The gridless function is a function of avoiding limitations of wavelength division multiplexing and bands on an optical frequency (or wavelength) grid of uniform grid spacing.

Japanese Laid-open Patent Publication Nos. 2014-175835, 2017-034542, 2012-105223, and 06-120895 are disclosed as related art.

### SUMMARY

According to an aspect of the embodiments, there is provided an optical switching device including: an input unit to which multichannel light beams are redundantly input; a channel tunable optical filter that confirms, from the received multichannel light beams, whether correct input of a channel for an output destination is included; and an optical switch that outputs, to an optical transfer device which is the output destination, any one of the multichannel light beams that includes the channel which has been correctly input.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a wavelength division multiplexing (WDM) network;

FIG. 2 is an example of an optical switching system;

FIG. 3 is an example of an optical path switching device;

FIG. 4 is an example of a wavelength identification unit;

FIG. 5 is a flowchart illustrating an example of behavior of the optical path switching device;

FIG. 6A is a flowchart illustrating an example of a first control process; FIG. 6B is a flowchart illustrating an example of a second control process;

FIG. 7 is a graph illustrating an example of the relationships among a drive voltage, a central wavelength, and a reception light current of a tunable optical filter (TOF);

FIG. 8 is an example of an optical spectrum in the TOF; and

FIG. 9 is a diagram explaining an example of an effect.

### DESCRIPTION OF EMBODIMENTS

Switching of the optical path from the active optical transfer path to the standby optical transfer path according to the second method is performed by using an optical path switching device. The optical path switching device makes the optical transfer path redundant with the active optical transfer path and the standby optical transfer path. The optical path switching device is provided, for example, between the transponder and the ROADM (hereinafter, referred to as a ROADM device) having the CDCG functions. Since the second method is used, one transponder is used for one wavelength.

A multiwavelength light beam (for example, a WDM signal light beam or the like) output from an adjacent ROADM device is input to the ROADM device. When the multiwavelength light beam is input, the ROADM device separates a wavelength light beam of an arbitrary wavelength from the multiwavelength light beam and outputs the separated wavelength light beam to the optical path switching device so as to introduce the separated wavelength light beam to the transponder. The wavelength of the wavelength light beam to be separated is set by a network management device coupled to the ROADM device. Based on the setting, the ROADM device may separate a single-wavelength light beam (hereinafter, referred to as a single-channel light beam) of one of the wavelengths (single wavelength) from a multiwavelength light beam in some cases or separate a multi-wavelength light beam (hereinafter, referred to as a multichannel light beam) including a plurality of wavelengths in other cases.

With a single-channel light beam, the optical path switching device may switch the optical path to the standby optical transfer path at the time when a problem occurs in the active optical transfer path and input of the single-channel light beam is unable to be detected. Since one transponder corresponds to one wavelength, the optical path switching device may output the single-channel light beam to the transponder that is an output destination.

Meanwhile, in the case of multichannel light beam, even when the optical path switching device switches the optical path from the active optical transfer path to the standby optical transfer path, the multichannel light beam does not necessarily include one wavelength corresponding to the transponder. For this reason, unless this wavelength is identified from the multichannel light beam, even when the optical path is switched, the optical path switching device is unable to output to the transponder the multichannel light beam including the wavelength corresponding to the transponder. For example, in a case where the multichannel light beam output from the ROADM device is input, the optical path switching device is unable to switch the optical path until correct input of the one wavelength corresponding to the transponder is confirmed.

Accordingly, in one aspect, it is an object to provide an optical switching device, an optical switching system, and a method of optical switching that highly accurately identify a channel of an output destination from multichannel light beam.

An embodiment for carrying out the present disclosure will be described below with reference to the drawings.

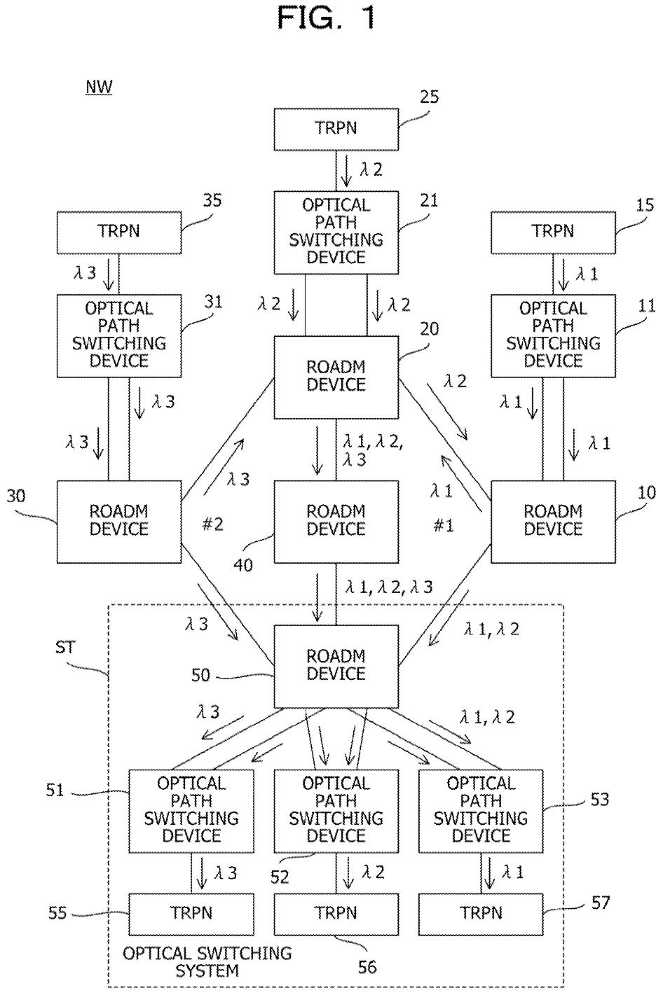

As illustrated in FIG. 1, a wavelength division multiplexing (WDM) network NW includes ring networks #1 and #2. Each of the ring networks #1 and #2 transfers various channel light beams such as single-channel light beams and multichannel light beams via optical transfer paths (for example, optical fibers).

For example, the ring network #1 transfers a single-channel light beam of a wavelength λ1 or a single-channel light beam of a wavelength λ2. The ring network #1 transfers a multichannel light beam of the wavelengths including λ1 and λ2 that are different from each other and a multichannel light beam of the wavelengths including λ1, λ2, and λ3 that are different from each other. Likewise, the ring network #2 transfers a single-channel light beam of the wavelengths λ3 and a multichannel light beam of the wavelengths including λ1, λ2, and λ3 that are different from each other. A multichannel light beam may be a channel light beam formed by multiplexing (or combining), by using a WDM technique, wavelengths that are different from each other.

The ring networks #1 and #2 include a plurality of ROADM (reconfigurable optical add/drop multiplexer) devices 10, 20, 30, 40, and 50. The ring networks #1 and #2 share the ROADM devices 20, 40, and 50. The ROADM device 10 is coupled to the ROADM devices 20 and 50 in different stations via the optical transfer paths. The ROADM device 10 is coupled to an optical path switching device 11 in the same station via intra-station wiring shorter than an optical transfer path. The ROADM device 20 is coupled to the ROADM devices 10, 30, and 40 in the different stations via the optical transfer paths. The ROADM device 20 is coupled to an optical path switching device 21 via intra-station wiring in the same station. The ROADM device 30 is coupled to the ROADM devices 20 and 50 in the different stations via the optical transfer paths. The ROADM device 30 is coupled to an optical path switching device 31 via intra-station wiring in the same station. The ROADM device 40 is coupled to the ROADM devices 20 and 50 in the different stations via the optical transfer paths. The ROADM device 50 is coupled to the ROADM devices 10, 30, and 40 in the different stations via the optical transfer paths. The ROADM device 50 is coupled to three optical path switching devices 51, 52, and 53 via intra-station wiring in the same station. The optical path switching devices 11, 21, 31, 51, 52, and 53 are examples of an optical switching device.

The optical path switching device 11 is coupled to a transponder (denoted as TRPN in FIG. 1) 15 via intra-station wiring in the same station. The optical path switching device 21 is coupled to a transponder 25 via intra-station wiring in the same station. The optical path switching device 31 is coupled to a transponder 35 via intra-station wiring in the same station. The optical path switching devices 51, 52, and 53 are respectively coupled to transponders 55, 56, and 57 via intra-station wiring in the same station. The transponders 15, 25, 35, 55, 56, and 57 are examples of optical transfer devices.

The transponder 15 outputs a single-channel light beam of the wavelength λ1. This single-channel light beam of the wavelength λ1 is input to the optical path switching device 11. When the single-channel light beam of the wavelength λ1 is input, the optical path switching device 11 splits the single-channel light beam of the wavelength λ1 into two light beams and outputs both to the ROADM device 10. Since the transponders 25 and 35 and the optical path switching devices 21 and 31 are basically similar to the transponder 15 and the optical path switching device 11, detailed description thereof is omitted.

The ROADM device 10 outputs one of the single-channel light beams of the wavelength λ1 to a ROADM device 20. The ROADM device 10 combines the other single-channel light beam of the wavelength λ1 with the single-channel light beam of the wavelength λ2 input to the ROADM device 10, generates a multichannel light beam of the wavelengths λ1 and λ2, and outputs the generated multichannel light beam to the ROADM device 50. The ROADM device 20 outputs one of single-channel light beams of the wavelength λ2 to a ROADM device 10. The ROADM device 20 combines the other single-channel light beams of the wavelength λ2 with the single-channel light beam of the wavelength λ1 and the single-channel light beam of the wavelength λ3 input to the ROADM device 20, generates a multichannel light beam of the wavelengths λ1, λ2, and λ3, and outputs the generated multichannel light beam to the ROADM device 40.

The ROADM device 30 outputs one of single-channel light beams of the wavelength λ3 to the ROADM device 20 and outputs the other single-channel light beam of the wavelength λ3 to the ROADM device 50. The ROADM device 40 amplifies the multichannel light beam of the wavelengths λ1, λ2, and λ3 input thereto and outputs the amplified multichannel light beam to the ROADM device 50. The ROADM device 50 outputs the single-channel light beam of the wavelength λ3 input thereto to the optical path switching device 51. The ROADM device 50 outputs the multichannel light beam of the wavelengths λ1, λ2, and λ3 input thereto to the optical path switching devices 51, 52, and 53. The ROADM device 50 outputs the multichannel light beam of the wavelengths λ1 and λ2 input thereto to the optical path switching devices 52 and 53. Thus, in some cases, the ROADM device 50 outputs the multichannel light beam to the optical path switching devices 51, 52, and 53.

The optical path switching device 51 identifies the wavelength λ3 corresponding to the transponder 55 from the multichannel light beam of the wavelengths λ1, λ2, and λ3 input thereto. Upon identifying the wavelength λ3, the optical path switching device 51 outputs to the transponder 55 one of the multichannel light beam of the wavelengths including the wavelengths λ1, λ2, and λ3 input thereto and the single-channel light beam of the wavelength λ3 input thereto. For example, in a normal state which is a correct operating state without the occurrences of a problem in an active optical transfer path, the optical path switching device 51 outputs to the transponder 55 the single-channel light beam of the wavelength λ3 input thereto. In contrast, in an abnormal state in which a problem occurs in the active optical transfer path, the optical path switching device 51 outputs to the transponder 55 the multichannel light beam of the wavelengths λ1, λ2, and λ3 input thereto.

In the normal state, the optical path switching device 52 identifies the wavelength λ2 corresponding to the transponder 56 from the multichannel light beam of the wavelengths λ1, λ2, and λ3 input thereto. Upon identifying the wavelength λ2, the optical path switching device 52 outputs to the transponder 56 the multichannel light beam of the wavelengths including λ1, λ2, and λ3 input thereto. In the abnormal state, the optical path switching device 52 identifies the wavelength λ2 corresponding to the transponder 56 from the multichannel light beam of the wavelengths λ1 and λ2 input thereto. Upon identifying the wavelength λ2, the optical path switching device 52 outputs to the transponder 56 the multichannel light beam of the wavelengths including λ1 and λ2 input thereto.

In the normal state, the optical path switching device 53 identifies the wavelength λ1 corresponding to the transponder 57 from the multichannel light beam of the wavelengths λ1, λ2, and λ3 input thereto. Upon identifying the wavelength λ1, the optical path switching device 53 outputs to the transponder 57 the multichannel light beam of the wavelengths including λ1, λ2, and λ3 input thereto. In the abnormal state, the optical path switching device 53 identifies the wavelength λ1 corresponding to the transponder 57 from the multichannel light beam of the wavelengths λ1 and λ2 input thereto. Upon identifying the wavelength λ1, the optical path switching device 53 outputs to the transponder 57 the multichannel light beam of the wavelengths including λ1 and λ2 input thereto.

As described above, since a method in which a single transponder is used for a single wavelength is used according to the present embodiment, the single-channel light beam of the single wavelength λ3 is input to the transponder 55. Likewise, the single-channel light beam of the single wavelength λ2 is input to the transponder 56, and the single-channel light beam of the single wavelength λ1 is input to the transponder 57. As illustrated in FIG. 1, an optical switching system ST may be built by the ROADM device 50, the optical path switching devices 51, 52, and 53, and the transponders 55, 56, and 57.

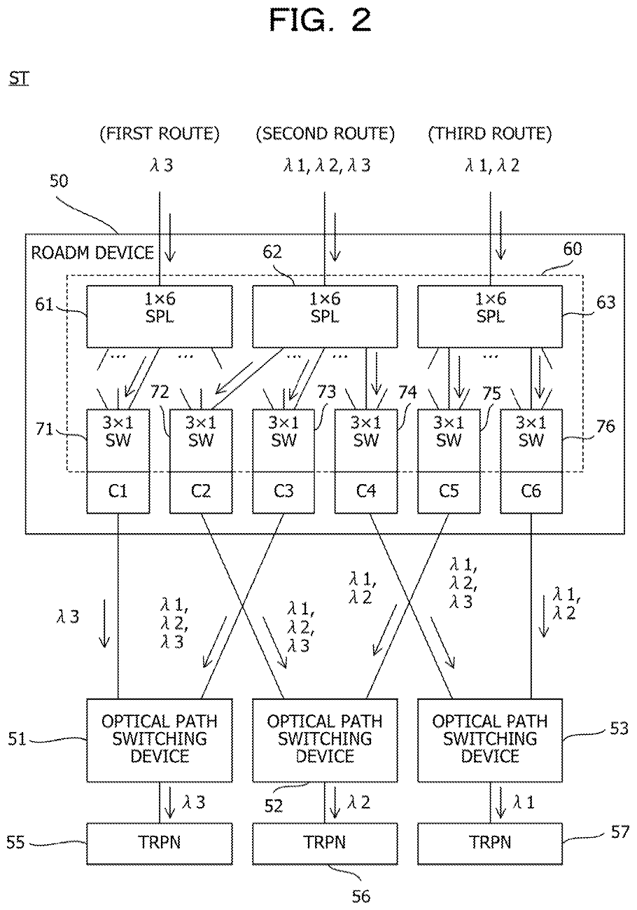

Next, with reference to FIG. 2, the details of the ROADM device 50 are described. Since the ROADM devices 10, 20, 30, and 40 basically have a similar configuration as that of the ROADM device 50, detailed description of the configuration of the ROADM devices 10, 20, 30, and 40 is omitted.

The ROADM device 50 includes a multicast switch (MCS) 60 and six client-side optical input/output ports (hereafter, simply referred to as optical ports) C1, C2, C3, C4, C5, and C6. Six optical ports C1, C2, C3, C4, C5, and C6 are coupled to the MCS 60. The optical ports C1 and C3 are coupled to the optical path switching device 51. The optical ports C2 and C5 are coupled to the optical path switching device 52. The optical ports C4 and C6 are coupled to the optical path switching device 53. The MCS 60 includes three 1×6 optical splitters (denoted as SPLs in FIG. 2 and the subsequent drawings) 61, 62, and 63 and six 3×1 optical switches (denoted as SWs in FIG. 2 and the subsequent drawings) 71, 72, 73, 74, 75, and 76. Referring to FIG. 2, although the 1×6 optical splitters 61, 62, and 63 are each coupled to all the 3×1 optical switches 71, 72, 73, 74, 75, and 76, the coupling is partly omitted from the drawing.

The 1×6 optical splitter 61 splits into six the single-channel light beam of the wavelength λ3 input from a first route of the ROADM device 50. The 1×6 optical splitter 62 splits into six the multichannel light beam of the wavelengths λ1, λ2, and λ3 input from a second route of the ROADM device 50. The 1×6 optical splitter 63 splits into six the multichannel light beam of the wavelengths λ1 and λ2 input from a third route of the ROADM device 50. The routes refer to optical transfer paths extending to coupling targets.

The 3×1 optical switch 71 selects, as the route, the first route which is desired one from among the first route, the second route, and the third route and outputs the single-channel light beam from the first route to the optical port C1 coupled to the 3×1 optical switch 71. For example, the multichannel light beams input from the second route and third route are blocked. Thus, contention of the same wavelength λ3 at the optical port C1 may be avoided. The 3×1 optical switch 71 outputs the single-channel light beam of the wavelength λ3 to the optical path switching device 51 via the optical port C1.

Each of the 3×1 optical switches 72, 73, and 74 selects, as the route, the second route which is desired one from among the first route, the second route, and the third route. The 3×1 optical switches 72, 73, and 74 output the multichannel light beam from the second route from the optical ports C2, C3, and C4 respectively coupled to the 3×1 optical switches 72, 73, and 74. For example, both the single-channel light beam input from the first route and the multichannel light beam input from the third route are blocked. Thus, contention of the same wavelength λ2 at the optical ports C2, C3, and C4 may be avoided. The 3×1 optical switches 72, 73, and 74 output, respectively via the optical ports C2, C3, and C4, the multichannel light beam of the wavelengths λ1, λ2, and λ3 to the optical path switching devices 52, 51, and 53.

Each of the 3×1 optical switches 75 and 76 selects, as the route, the third route which is desired one from among the first route, the second route, and the third route. The 3×1 optical switches 75 and 76 output the multichannel light beam from the third route from the optical ports C5 and C6 respectively coupled to the 3×1 optical switches 75 and 76. For example, both the single-channel light beam input from the first route and the multichannel light beam input from the second route are blocked. Thus, contention of the same wavelength λ1 at the optical ports C5 and C6 may be avoided. The 3×1 optical switches 75 and 76 output, respectively via the optical ports C5 and C6, the multichannel light beam of the wavelengths λ1 and λ2 to the optical path switching devices 52 and 53.

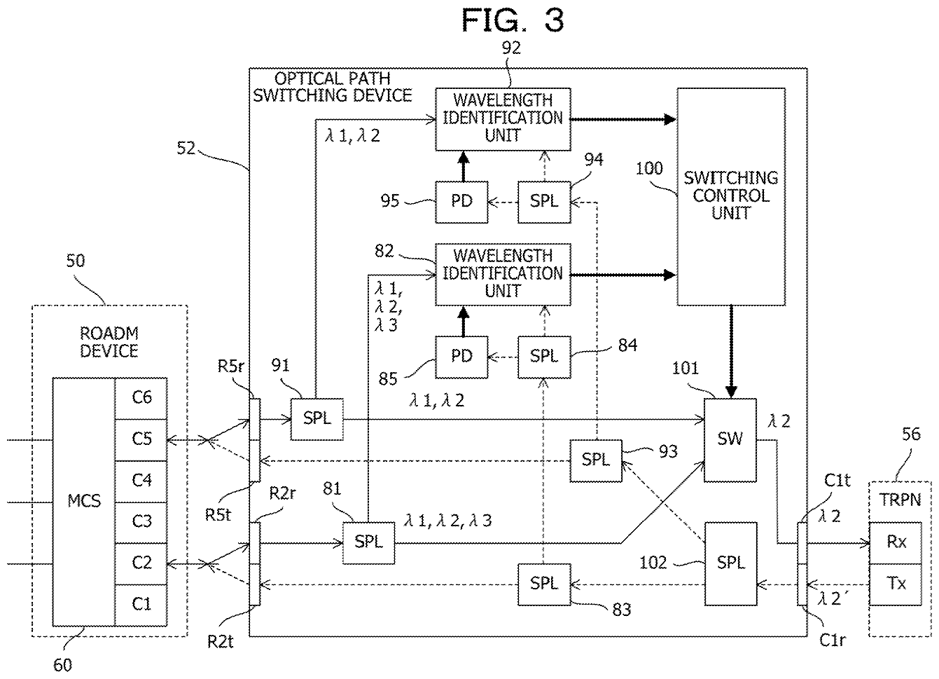

Next, with reference to FIG. 3, the details of the optical path switching device 52 are described. Since the optical path switching devices 51 and 53 basically have a similar configuration as that of the optical path switching device 52, detailed description of the configuration of the optical path switching devices 51 and 53 is omitted.

The optical path switching device 52 includes optical splitters 81 and 91, wavelength identification units 82 and 92, a switching control unit 100, and an optical switch 101. The optical path switching device 52 also includes optical splitters 83, 84, 93, 94, and 102 and photodiodes (denoted as PDs in FIG. 3 and the subsequent drawing) 85 and 95. Furthermore, the optical path switching device 52 includes ROADM-side optical input ports R2r and R5r, ROADM-side optical output ports R2t and R5t, a client-side optical output port C1t, and a client-side optical input port C1r. The ROADM-side optical input ports R2r and R5r are examples of an input unit.

According to the present embodiment, as an example, an optical path coupling the optical splitter 81 and the optical switch 101 is described as an active optical path, and an optical path coupling the optical splitter 91 and the optical switch 101 is described as a standby optical path. The optical path coupling the optical splitter 91 and the optical switch 101 may be set as the active optical path, and the optical path coupling the optical splitter 81 and the optical switch 101 may be set as the standby optical path.

The optical splitter 81 is coupled to the ROADM-side optical input port R2r. The ROADM-side optical input port R2r is coupled to the optical port C2 via the intra-station wiring in the same station as that of the optical port C2. Accordingly, the multichannel light beam of the wavelengths λ1, λ2, and λ3 output from the optical port C2 is input to the ROADM-side optical input port R2r. As a result, the multichannel light beam of the wavelengths λ1, λ2, and λ3 output from the ROADM-side optical input port R2r is input to the optical splitter 81. The optical splitter 81 is also coupled to the wavelength identification unit 82 and the optical switch 101. Accordingly, the optical splitter 81 may split the multichannel light beam of the wavelengths λ1, λ2, and λ3 into two light beams and output the two light beams respectively to the wavelength identification unit 82 and the optical switch 101.

The optical splitter 91 is coupled to the ROADM-side optical input port R5r. The ROADM-side optical input port R5r is coupled to the optical port C5 via the intra-station wiring. Accordingly, the multichannel light beam of the wavelengths λ1 and λ2 output from the optical port C5 is input to the ROADM-side optical input port R5r. As a result, the multichannel light beam of the wavelengths λ1 and λ2 output from the ROADM-side optical input port R5r is input to the optical splitter 91. The optical splitter 91 is also coupled to the wavelength identification unit 92 and the optical switch 101. Accordingly, the optical splitter 91 may split the multichannel light beam of the wavelengths λ1 and λ2 into two light beams and output the two light beams respectively to the wavelength identification unit 92 and the optical switch 101.

As described above, the multichannel light beam of the wavelengths λ1, λ2, and λ3 and the multichannel light beam of the wavelengths λ1 and λ2 are redundantly input to the optical path switching device 52 by the ROADM-side optical input ports R2r and R5r.

The multichannel light beam of the wavelengths λ1, λ2, and λ3 output from the optical splitter 81 is input to the wavelength identification unit 82. When this multichannel light beam is input to the wavelength identification unit 82, the wavelength identification unit 82 checks whether the multichannel light beam includes one specific wavelength λ2 corresponding to the transponder 56. For example, in the above-described normal state, the wavelength identification unit 82 may confirm that the multichannel light beam includes the wavelength λ2. In contrast, in some cases, in the above-described abnormal state, the multichannel light beam is not necessarily input to the wavelength identification unit 82. In the abnormal state, even when the multichannel light beam is input to the wavelength identification unit 82, there is a possibility that the multichannel light beam does not include the wavelength λ2. In such cases, the wavelength identification unit 82 may confirm that the multichannel light beam does not include the wavelength λ2. The detailed configuration of the wavelength identification unit 82 will be described later. Since the wavelength identification unit 92 is basically similar to the wavelength identification unit 82, detailed description thereof will be omitted.

The switching control unit 100 monitors the wavelength identification units 82 and 92 and controls switching of the optical switch 101 based on results of monitoring. For example, when the normal state is shifted to the abnormal state, the switching control unit 100 switches the optical path of the optical switch 101 from the active optical path to the standby optical path. Meanwhile, in a case where the optical transfer path recovers from a problem and the abnormal state is shifted to the normal state, the switching control unit 100 may switch or does not necessarily switch the optical path of the optical switch 101 from the standby optical path to the active optical path. For example, in a case where, after recovering from the problem, the standby optical path is newly operated as the active optical path and the original active optical path is newly operated as the standby optical path, the switching control unit 100 does not necessarily switch the optical path of the optical switch 101 from the standby optical path to the active optical path.

The switching control unit 100 may be realized by using a hardware circuit. The hardware circuit may be a memory and a processor including a central processing unit (CPU) or may be a field-programmable gate array (FPGA). The hardware circuit may be a large-scale integration (LSI) or an application-specific integrated circuit (ASIC).

In a case where the optical path is set to the active optical path by the control, the optical switch 101 outputs the multichannel light beam including the wavelengths λ1, λ2, and λ3 input from the optical splitter 81. In a case where the optical path is set to the standby optical path by the control, the optical switch 101 outputs the multichannel light beam including the wavelengths λ1 and λ2 input from the optical splitter 91.

The optical switch 101 is coupled to the client-side optical output port C1t. The client-side optical output port C1t is coupled to a reception unit Rx of the transponder 56 in the same station via the intra-station wiring. Accordingly, the multichannel light beam output from the optical switch 101 is input to the reception unit Rx of the transponders 56 via the client-side optical output port C1t.

As described above, the optical switch 101 outputs, to the transponder 56, the multichannel light beam including the wavelength λ2 which is a target of the transponder 56 coupled to the optical path switching device 52. When the optical switch 101 is in the normal state in which the optical path is set to the active optical path by the control, the optical switch 101 outputs the multichannel light beam including the wavelengths λ1, λ2, and λ3 to the transponder 56. When the optical switch 101 is in the abnormal state in which the optical path is set to the standby optical path by the control, the optical switch 101 outputs the multichannel light beam including the wavelengths λ1 and λ2 to the transponder 56. For example, the optical switch 101 outputs the multichannel light beam including the wavelength λ2 which is the target of the transponder 56 in both a correct state and the abnormal state.

The optical splitter 102 is coupled to the client-side optical input port C1r. The client-side optical input port C1r is coupled to a transmission unit Tx of the transponder 56 in the same station via the intra-station wiring. Accordingly, a single-channel light beam of a wavelength λ2′ (hereafter, referred to as a transmission light beam of the wavelength λ2′) transmitted from the transmission unit Tx is input to the client-side optical input port C1r. The transmission light beam of the wavelength λ2′ output from the client-side optical input port C1r is input to the optical splitter 102. The wavelength λ2′ is in common with the wavelength λ2. For example, the wavelength λ2′ is the same as or approximate to the wavelength λ2. Furthermore, the optical splitter 102 is coupled to the optical splitters 83 and 93. Accordingly, the optical splitter 102 may split the transmission light beam of the wavelength λ2′ into two light beams and output the two light beams respectively to the optical splitters 83 and 93.

The optical splitter 83 is coupled to the ROADM-side optical output port R2t and the optical splitter 84. The optical splitter 83 splits the transmission light beam of the wavelength λ2′ into two light beams and output the two light beams respectively to the ROADM-side optical output port R2t and the optical splitter 84. The ROADM-side optical output port R2t is coupled to the optical port C2 via the intra-station wiring in the same station as that of the optical port C2. Accordingly, the transmission light beam of the wavelength λ2′ is input to the ROADM-side optical output port R2t. The transmission light beam of the wavelength λ2′ output from the ROADM-side optical output port R2t is input to the optical port C2.

The optical splitter 93 is coupled to the ROADM-side optical output port R5t and the optical splitter 94. The optical splitter 93 splits the transmission light beam of the wavelength λ2′ into two light beams and output the two light beams respectively to the ROADM-side optical output port R5t and the optical splitter 94. The ROADM-side optical output port R5t is coupled to the optical port C5 via the intra-station wiring in the same station as that of the optical port C5. Accordingly, the transmission light beam of the wavelength λ2′ output from the optical splitter 93 is input to the ROADM-side optical output port R5t. The transmission light beam of the wavelength λ2′ output from the ROADM-side optical output port R5t is input to the optical port C5.

The optical splitter 84 splits the transmission light beam of the wavelength λ2′ into two beams and outputs the two light beams respectively to the wavelength identification unit 82 and the photodiode 85. Based on the transmission light beam of the wavelength λ2′ input from the optical splitter 84, the wavelength identification unit 82 checks whether the multichannel light beam includes one specific wavelength λ2 corresponding to the transponder 56. The photodiode 85 detects the reception light power of the transmission light beam of the wavelength λ2′ input from the optical splitter 84. Although the optical splitter 84 and the photodiode 85 are provided in the optical path switching device 52 according to the present embodiment, the optical splitter 84 and the photodiode 85 may be omitted, instead of being provided, depending on content of the control under the switching control unit 100 to be described later.

The optical splitter 94 splits the transmission light beam of the wavelength λ2′ into two beams and outputs the two light beams respectively to the wavelength identification unit 92 and the photodiode 95. Based on the transmission light beam of the wavelength λ2′ input from the optical splitter 94, the wavelength identification unit 92 checks whether the multichannel light beam includes one specific wavelength λ2 corresponding to the transponder 56. The photodiode 95 detects the reception light power of the transmission light beam of the wavelength λ2′ input from the optical splitter 94. Although the optical splitter 94 and the photodiode 95 are provided in the optical path switching device 52 according to the present embodiment, the optical splitter 94 and the photodiode 95 may be omitted, instead of being provided, depending on the above-described content of the control.

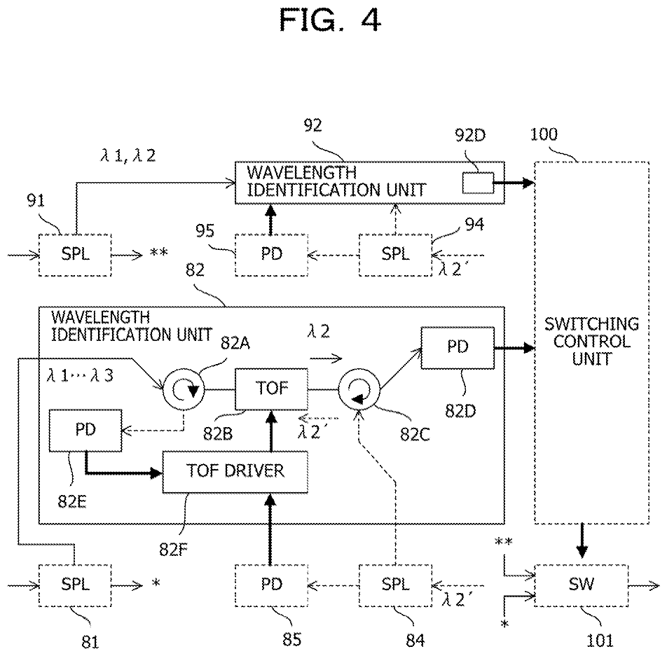

Next, with reference to FIG. 4, the details of the wavelength identification unit 82 are described.

The wavelength identification unit 82 includes a first optical circulator 82A, a tunable optical filter (TOF) 82B, a second optical circulator 82C, photodiodes 82D and 82E, and a TOF driver 82F. The first optical circulator 82A and the second optical circulator 82C are arranged in front of and behind the TOF 82B. The TOF 82B is an example of a channel tunable optical filter. The second optical circulator 82C is an example of an optical circuit. The photodiode 82D is an example of a first photoreceptor. The photodiode 82E is an example of a second photoreceptor. The TOF driver 82F is an example of a drive unit. The photodiode 85 provided outside the wavelength identification unit 82 illustrated in FIG. 4 is an example of a third photoreceptor.

Each of the first optical circulator 82A and the second optical circulator 82C is a three port-type optical circulator. In a three port-type optical circulator, light input to a first port is output from a second port. Light input to the second port is output from a third port. Light input to the third port is output from the first port.

Since the wavelength identification unit 92 is basically has a similar configuration to that of the wavelength identification unit 82, detailed description of the configuration of the wavelength identification unit 92 is omitted. For example, the wavelength identification unit 92 includes a photodiode 92D similar to the photodiode 82D included in the wavelength identification unit 82.

As for the first optical circulator 82A, when the multichannel light beam of the wavelengths λ1, λ2, and λ3 is input to the wavelength identification unit 82, this multichannel light beam is input to the first port of the first optical circulator 82A. When the multichannel light beam of the wavelengths λ1, λ2, and λ3 is input to the first port, the first optical circulator 82A outputs the multichannel light beam from the second port of the first optical circulator 82A coupled to the TOF 82B. Thus, the multichannel light beam of the wavelengths λ1, λ2, and λ3 is input to the TOF 82B. Meanwhile, when the transmission light beam of the wavelength λ2′ having passed through the TOF 82B is input to the second port, the first optical circulator 82A outputs the transmission light beam from the third port of the first optical circulator 82A coupled to the photodiode 82E. Thus, the transmission light beam of the wavelength λ2′ is input to the photodiode 82E.

The TOF 82B allows part of the single-channel light beam having one specific wavelength to pass therethrough based on a drive voltage output from the TOF driver 82F. For example, TOF 82B limits (for example, regulates) passage of a single-channel light beam or a multichannel light beam having a remaining wavelength or remaining wavelengths excluding the one specific wavelength therethrough. According to the present embodiment, the TOF 82B appropriately performs control so as to allow part of the single-channel light beam of the wavelength λ2 corresponding to the transponder 56 to pass therethrough. The details of the control will be described later. In such an appropriately controlled state, when the multichannel light beam of the wavelengths λ1, λ2, and λ3 is input to the TOF 82B, the TOF 82B causes part of the single-channel light beam of the wavelength λ2 to pass therethrough. Thus, the TOF 82B may check the presence/absence of the wavelength λ2 or confirm correct input of the wavelength λ2 for the multichannel light beam of the wavelengths λ1, λ2, and λ3. Since the wavelength λ2 and the wavelength λ2′ are in common with each other, the TOF 82B also allows part of the transmission light beam of the wavelength λ2′ to pass therethrough.

As for the second optical circulator 82C, when the transmission light beam of the wavelength λ2′ is input to the wavelength identification unit 82, this transmission light beam is input to the third port of the second optical circulator 82C. When the transmission light beam of the wavelength λ2′ is input to the third port, the second optical circulator 82C outputs the transmission light beam from the first port of the second optical circulator 82C coupled to the TOF 82B. Thus, the transmission light beam of the wavelength λ2′ is input to the TOF 82B. Meanwhile, when part of the single-channel light beam of the wavelength λ2 having passed through the TOF 82B is input to the first port, the second optical circulator 82C outputs the single-channel light beam from the second port of the second optical circulator 82C coupled to the photodiode 82D. Thus, the part of the single-channel light beam of the wavelength λ2 is input to the photodiode 82D.

The photodiode 82D detects the reception light power of the part of the single-channel light beam of the wavelength λ2 input thereto. The photodiode 82E detects the reception light power of the part of the transmission light beam of the wavelength λ2′ input thereto.

The TOF driver 82F monitors the reception light current corresponding to the reception light power detected by the photodiode 85 and waits until the reception light current becomes greater than or equal to a predetermined value. When the reception light current becomes greater than or equal to the predetermined value, the TOF driver 82F determines that the transmission light beam of the wavelength λ2′ is input to the optical path switching device 52. Thus, the TOF driver 82F starts a first control process at the time of start-up of the optical path switching device 52. Although the details will be described later, the first control process is a process of sweeping the drive voltage to find a drive voltage at which the reception light current corresponding to the reception light power detected by the photodiode 82E is maximized.

When the first control process ends, the TOF driver 82F shifts to an operating state and starts a second control process, which will be described later. The second control process is a process of performing dither control on the drive voltage at low speed based on the reception light current corresponding to the reception light power detected by the photodiode 82E, thereby to maintain a central wavelength of the TOF 82B. The dither control is control in which a dither signal is superposed on the drive voltage and includes control in which the drive voltage oscillates little by little. Instead of the photodiode 82E, the photodiode 82D may be utilized. The TOF driver 82F may be realized by using the hardware circuit described above. The TOF driver 82F may be integrated with the switching control unit 100 (for example, a single chip) or may be separate from the switching control unit 100 (for example, two or more chips).

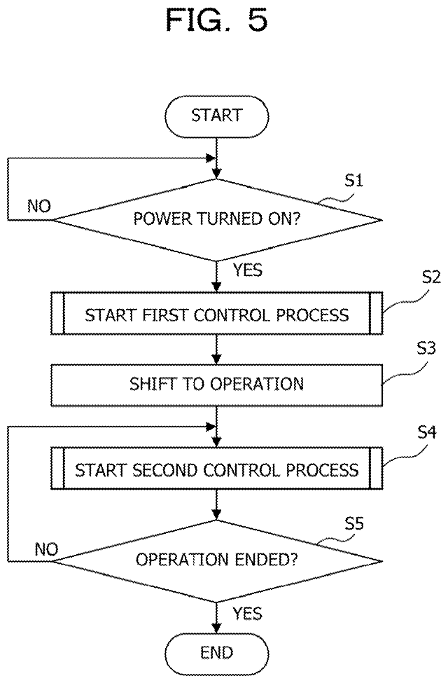

Next, with reference to FIG. 5, an outline of behavior of the optical path switching device 52 is described. In the optical path switching device 52, the TOF driver 82F and the switching control unit 100 behave in a cooperating manner. Since the optical path switching devices 51 and 53 basically behave in a similar manner as that of the optical path switching device 52, detailed description of the behavior of the optical path switching devices 51 and 53 is omitted.

First, the TOF driver 82F waits until the power of the optical path switching device 52 is turned on (step S1: NO). When the power is turned on (step S1: YES), the power is supplied to the optical path switching device 52, and the TOF driver 82F starts the first control process, which will be described later (step S2). When the first control process ends, the TOF driver 82F shifts to the operating state (step S3) and starts the second control process, which will be described later (step S4).

When the second control process ends, the TOF driver 82F repeats the second control process until the operating state ends (step S5: NO). For example, the second control process is repeated during the operation. When the operating state ends (step S5: YES), the TOF driver 82F ends the process. For example, when maintenance work or replacement is performed on the optical path switching device 52, the operating state ends and the TOF driver 82F ends the process.

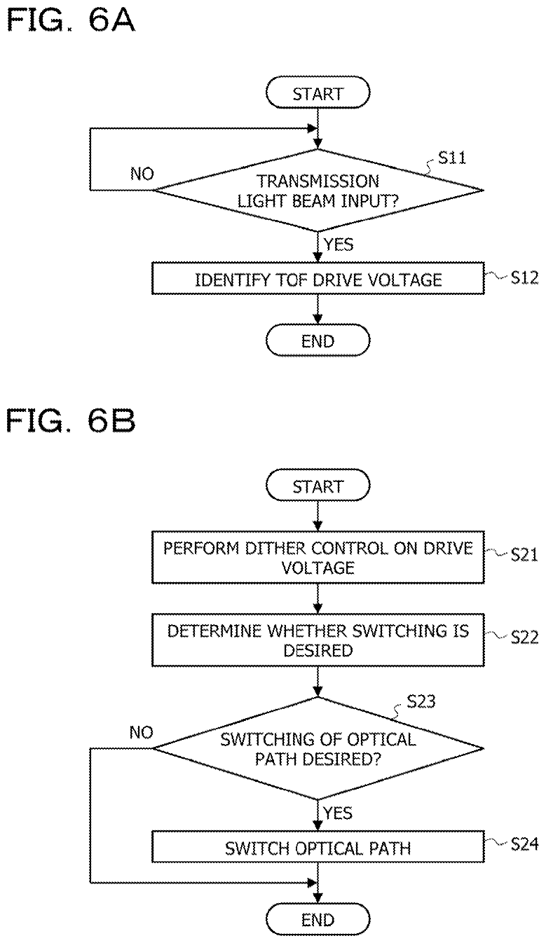

Next, the details of the first control process and the second control process described above are described with reference to FIGS. 6A to 8.

First, the first control process is described. As illustrated in FIG. 6A, when the first control process is started, the TOF driver 82F waits until the transmission light beam of the wavelength λ2′ is input to the optical path switching device 52 (step S11: NO). For example, the TOF driver 82F monitors the reception light current corresponding to the reception light power detected by the photodiode 85 and waits until the reception light current becomes greater than or equal to the predetermined value. When the reception light current becomes greater than or equal to the predetermined value, the TOF driver 82F determines that the transmission light beam of the wavelength λ2′ is input to the optical path switching device 52 (step S11: YES). When the transmission light beam of the wavelength λ2′ is input, the TOF driver 82F identifies the drive voltage of the TOF 82B based on the reception light current corresponding to the reception light power detected by the photodiode 82E (step S12) and ends the first control process.

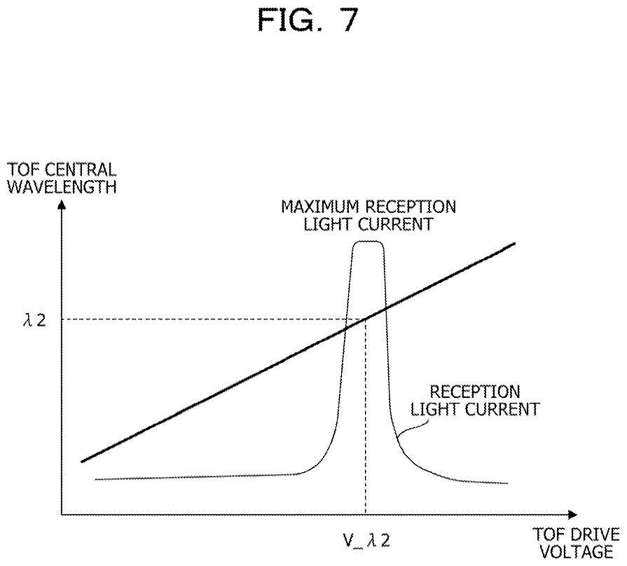

For example, as illustrated in FIG. 7, the TOF driver 82F identifies the maximum reception light current from the reception light current corresponding to the reception light power detected by the photodiode 82E and finds and identifies a drive voltage V_λ2 corresponding to the identified maximum reception light current. Although the central wavelength (or a central channel) that the TOF 82B causes to pass therethrough varies in accordance with the drive voltage, when the TOF 82B is controlled at this drive voltage V_λ2, the reception light power of the transmission light beam of the wavelength λ2′ detected by the photodiode 82E is maximized. As a result, the reception light current is maximized.

As described above, the wavelength λ2′ and the wavelength λ2 are in common with each other. Accordingly, when the TOF 82B is controlled at the drive voltage V_λ2, not only the wavelength λ2′ but also the wavelength λ2 pass through the TOF 82B. In contrast, the wavelengths λ1 and λ3 different from the wavelength λ2 are blocked. Accordingly, when the multichannel light beam of the wavelengths λ1, λ2, and λ3 is input to the TOF 82B, the TOF 82B outputs part of the single-channel light beam of the wavelength λ2 due to the transmission light beam of the wavelength λ2′ input in an input direction opposite to the input direction of the multichannel light beam.

For example, when the TOF driver 82F controls the central wavelength of the TOF 82B to be a central wavelength λ2 at the drive voltage V_λ2 corresponding to the maximum reception light current, the TOF 82B outputs part of the single-channel light beam of the wavelength λ2. As described above, when the drive voltage V_λ2 is identified, the TOF driver 82F may control the central wavelength of the TOF 82B to be the central wavelength λ2 corresponding to the drive voltage V_λ2.

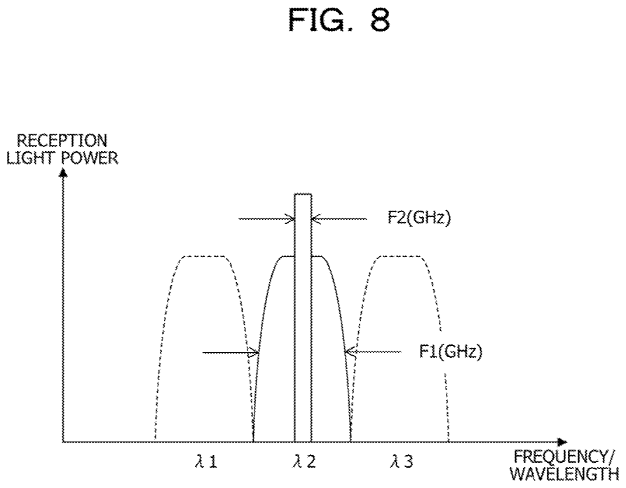

Accordingly, as illustrated in FIG. 8, even when the multichannel light beam of the wavelengths λ1, λ2, and λ3 is input to the TOF 82B, the TOF 82B causes part of the single-channel light beam of the wavelength λ2 to pass therethrough. For example, by cutting off an optical spectrum of the wavelength λ2 in a narrower frequency band F2 (gigahertz (GHz)) than a frequency band F1 (GHz) of the wavelengths λ2, mixing of the wavelengths λ1 and λ3 into part of the single-channel light beam of the wavelength λ2 output from the TOF 82B may be highly accurately avoided. The photodiode 82D detects the reception light power of such part of the single-channel light beam. The processing in step S11 may be omitted from the first control process. In this case, the optical splitters 84 and 94 and the photodiodes 85 and 95 may be omitted, and accordingly, the size of the optical path switching device 52 may be reduced.

Next, the second control process is described. As illustrated in FIG. 6B, when the second control process is started, the TOF driver 82F performs dither control on the drive voltage (step S21). In more detail, the TOF driver 82F performs dither control on the drive voltage at low speed to maintain the central wavelength (for example, the central channel) of the TOF 82B. The linear relationship between the drive voltage and the central wavelength of the TOF 82B described with reference to FIG. 7 changes in accordance with variations in temperature or a lapse of time. Accordingly, the TOF driver 82F performs dither control on the drive voltage at low speed to maintain the central wavelength of the TOF 82B. Consequently, the photodiode 82D may detect the reception light power of the single-channel light beam of the wavelength λ2 substantially continuously in a state in which the reception light power is close to the maximum.

Next, the switching control unit 100 determines whether switching of the optical path is desired (step S22). In more detail, the switching control unit 100 monitors an active reception light current corresponding to the reception light power detected by the photodiode 82D. Likewise, the switching control unit 100 monitors a standby reception light current corresponding to the reception light power detected by the photodiode 92D. Based on the active reception light current and the standby reception light current, the switching control unit 100 determines the presence/absence of the occurrence of a problem and determines whether switching of the optical path is desired.

In a case where switching of the optical path is desired (step S23: YES), the switching control unit 100 switches the optical path of the optical switch 101 (step S24) and the TOF driver 82F ends the second control process. In a case where switching of the optical path is not desired (step S23: NO), processing in step S24 is skipped and the TOF driver 82F ends the second control process.

For example, in a case where both the active reception light current and the standby reception light current are generated due to the redundancy of the optical transfer path, the switching control unit 100 determines that the state is the normal state. In this case, when the optical path of the optical switch 101 is maintained in the active optical path, the switching control unit 100 determines that the optical path is not desired to be switched. In a case where the active reception light current is not generated and the standby reception light current is generated, the switching control unit 100 determines that the state is the abnormal state. In this case, when the optical path of the optical switch 101 is the active optical path, the switching control unit 100 determines that the optical path is desired to be switched. When both the active reception light current and the standby reception light current are generated due to, for example, recovery from a problem in a state in which the optical path of the optical switch 101 is maintained in the standby optical path, the switching control unit 100 may determine that switching of the optical path is desired or not desired. For example, in a case where, after recovering from the problem, the standby optical path is newly operated as the active optical path and the original active optical path is newly operated as the standby optical path, the switching control unit 100 determines that switching of the optical path is not desired. Although both the multichannel light beam including the wavelengths λ1, λ2, and λ3 and the multichannel light beam including the wavelengths λ1 and λ2 are input to the optical switch 101, one of the multichannel light beam is output by the switching control.

As has been described, according to the present embodiment, the optical path switching device 52 includes the ROADM-side optical input ports R2r and R5r, the TOF 82B, and the optical switch 101. The multichannel light beam of the wavelengths λ1, λ2, and λ3 and the multichannel light beam of the wavelengths λ1 and λ2 are redundantly input to the ROADM-side optical input ports R2r and R5r. The TOF 82B confirms, from these multichannel light beams, correct input of the channel λ2 corresponding to the transponder 56 which is an output destination. The optical switch 101 outputs to the transponder 56 any one of the multichannel light beams including the channel λ2 correct input thereto. With these configurations, the optical path switching device 52 may highly accurately identify, from the multichannel light beams, the channel λ2 for the output destination and may appropriately switch the optical path.

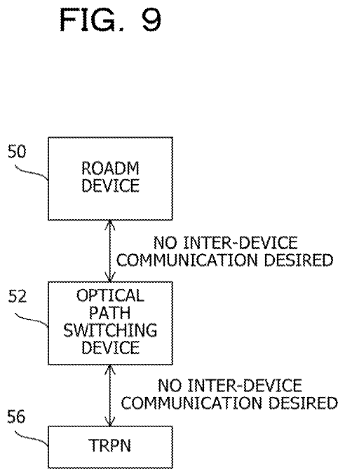

For example, according to the present embodiment, the optical path switching device 52 independently autonomously identifies the channel λ2 for the transponder 56 from the multichannel light beams without providing a special configuration in the ROADM device 50 or the transponder 56. Thus, as illustrated in, for example, FIG. 9, inter-device communication with the ROADM device 50 or the transponder 56 provided in the same optical switching system ST is not desired. This may provide a greater flexibility in selection of the ROADM device 50 and the transponder 56. Similarly to the optical path switching device 52, the optical path switching device 51 may autonomously identify the channel λ3 for the transponder 55. Furthermore, similarly to the optical path switching device 52, the optical path switching device 53 may autonomously identify the channel λ1 for the transponder 57.

Although the preferred embodiment of the present disclosure has been described in detail above, the present disclosure is not limited to the specific embodiment according to the present disclosure, and various modifications and changes may be made within a scope of the gist of the present disclosure described in the claims. For example, referring to FIGS. 1 and 2 described above, transfer of the channel light beams from the transponders 15, 25, and 35 to the transponders 55, 56, and 57 has been described as an example. However, transfer of the channel light beams from the transponders 55, 56, and 57 to the transponders 15, 25, and 35 may also be included in the present embodiment. For example, according to the present embodiment, transfer of the channel light beams may be performed not only unidirectionally but also bidirectionally.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical switching device comprising:
an input unit to which multichannel light beams are redundantly input;
a channel tunable optical filter that confirms, from the received multichannel light beams, whether correct input of a channel for an output destination is included; and
an optical switch that outputs, to an optical transfer device which is the output destination, any one of the multichannel light beams that includes the channel which has been correctly input.

2. The optical switching device according to claim 1, wherein
the channel tunable optical filter confirms the correct input of the channel for the output destination by limiting passage of the multichannel light beams through the channel tunable optical filter.

3. The optical switching device according to claim 1, wherein
the channel tunable optical filter confirms the correct input of the channel for the output destination by allowing passage, through the channel tunable optical filter, of part of a single-channel light beam of the channel for the output destination and regulating passage, through the channel tunable optical filter, of a single-channel light beam of a remaining channel excluding the channel for the output destination or a multichannel light beam of a remaining channel or remaining channels excluding the channel for the output destination.

4. The optical switching device according to claim 1, further comprising:
a first photoreceptor to which a single-channel light beam that is of the channel for the output destination and that has passed through the channel tunable optical filter is input; and
a switching control unit that switches, based on input to the first photoreceptor, the optical switch to output of the multichannel light beams that include the channel for the output destination.

5. The optical switching device according to claim 1, further comprising:
an optical circuit to which a transmission light beam of the channel for the output destination is input and which inputs to the channel tunable optical filter the transmission light beam in an input direction opposite to an input direction in which the multichannel light beams are input to the channel tunable optical filter;
a second photoreceptor to which the transmission light beam that has passed through the channel tunable optical filter is input; and
a drive unit that drives the channel tunable optical filter at a drive voltage at which reception light power of the transmission light beam input to the second photoreceptor is maximized.

6. The optical switching device according to claim 5, wherein
the transmission light beam transmitted from the optical transfer device is input to the optical circuit.

7. The optical switching device according to claim 5, further comprising:
a third photoreceptor to which the transmission light beam before passage through the channel tunable optical filter is input, wherein
the drive unit starts a process at start-up of the optical switching device based on input to the third photoreceptor.

8. The optical switching device according to claim 5, wherein
the drive unit maintains a central channel of the channel tunable optical filter by superposing a dither signal on the drive voltage.

9. An optical switching system comprising:
an optical add/drop multiplexer;
an optical transfer device; and
an optical switching device including
an input unit to which multichannel light beams are redundantly input from the optical add/drop multiplexer,
a channel tunable optical filter that confirms, from the received multichannel light beams, whether correct input of a channel for an output destination is included, and
an optical switch that outputs, to the optical transfer device which is the output destination, any one of the multichannel light beams that includes the channel which has been correctly input.

10. An optical switching method comprising:
receiving multichannel light beams redundantly;
confirming, from the received multichannel light beams, whether correct input of a channel for an output destination is included; and
outputting, to an optical transfer device which is the output destination, any one of the multichannel light beams that includes the channel which has been correctly input.
